(19) United States
(12) Patent Application Publication
(10) Pub. No.: US 2023/0365440 A1
(43) Pub. Date: Nov. 16, 2023

(54) SYSTEMS AND METHODS FOR ELECTROCHEMICAL REMEDIATION OF CONTAMINANTS

(71) Applicant: ACLARITY, INC., Mansfield, MA (US)

(72) Inventor: Orren David Schneider, Plainsboro, NJ (US)

(73) Assignee: ACLARITY, INC., Mansfield, MA (US)

(21) Appl. No.: 18/198,261

(22) Filed: May 16, 2023

Related U.S. Application Data
(60) Provisional application No. 63/342,400, filed on May 16, 2022.

(51) Int. Cl. C02F 1/461

(52) U.S. Cl. CPC C02F 1/46109; C02F 2001/46171; C02F 2101/36

(57) ABSTRACT

An electrochemical contaminant remediation system includes a conditioning tank and a flow-through electrochemical reactor. The flow-through electrochemical reactor includes a housing having an internal liquid flow-path. A first electrode is disposed within the internal liquid flow path. A second electrode is spaced apart from the flow-through or solid first electrode, thereby creating an electroactive gap between the flow-through or solid first electrode and the second electrode.

### CROSS REFERENCE TO RELATED APPLICATION

This application claims the benefit under 35 U.S.C. § 119(e) of U.S. provisional patent application Ser. No. 63/342,400, filed May 16, 2022, the entire disclosure of which is incorporated herein by reference.

### FIELD OF THE DISCLOSURE

The disclosure relates to systems and methods for remediating contaminants in liquids and more specifically to systems and methods for electrochemical remediation of contaminants.

### BACKGROUND

The problems of pollution and contamination of water continue to grow. Often, consumer waste is disposed of in landfills or similar collection sites. Chemicals from the waste can leach down into the underlying soil and eventually reach and contaminate ground water. Chemical groundwater contamination can pose significant health risks to the general population surrounding the contamination.

While some pollutants can break down into benign substances in the landfill, by exposure to biological agents, for example, other pollutants do not break down easily. Some examples of such pollutants that have recently been found in groundwater in significant quantities are perfluoroalkyl and polyfluoroalkyl substances, commonly referred to as “PFAS.” PFAS are durable chemicals having decay rates of essentially 0 under ambient conditions and exhibit good oil, water, temperature, chemical, and fire resistance. PFAS are found in a variety of consumer and industrial products, including but not limited to Teflon®, Scotchgard®, ski wax, clothing, cell phones, computers, tablets, semi-conductors, surgical gowns, commercial aircraft, low-emissions vehicles, and fire-fighting foams. As products containing PFAS reach the end of their useful life, they are often discarded in landfills. Because PFAS exhibits the beneficial qualities mentioned above, they are also very slow to degrade, and they are sometimes referred to as “forever chemicals” because it can take decades for these materials to degrade under ambient conditions.

While research on PFAS effects in humans is still being conducted, some potential health problems correlated with high PFAS levels in blood include increased cholesterol, decreased immune function, changes in liver enzymes, increases in blood pressure, and increases in some forms of cancer. PFAS can enter the blood stream in a number of ways, for example, by ingesting contaminated water, contaminated fish, poultry, or meat, contaminated soil or dust, or contaminated food wrapped or contained within packaging material that contains PFAS. Because of the potential harmful effects of PFAS, efforts are underway to mitigate the amount of PFAS in drinking water. One way to mitigate the amount of PFAS in drinking water is to reduce the amount of PFAS-containing materials disposed of in landfills. However, complete elimination of PFAS-containing materials is not feasible. However, PFAS that leaches into groundwater supplies may be effectively removed before or during treatment, for example, by a municipal water treatment plant, to make the water safer for consumption.

Currently, PFAS is most often removed from water by applying adsorption and filtration methods, such as activated carbon adsorption, ion exchange resin adsorption, and high-pressure (reverse osmosis or nanofiltration) membranes. However, current treatment methods are expensive, impractical for large scale treatment, can require high pressures, and can produce wastes containing very high concentrations of PFAS in waste streams. In addition, when activated carbon or ion exchange resins can no longer remove these compounds, they must be removed and are often incinerated as hazardous waste or are placed in landfills, thereby continuing the cycle of disposal and leaching.

### SUMMARY OF THE DISCLOSURE

According to some examples, an electrochemical contaminant remediation system includes a conditioning tank having an untreated liquid input and a conditioning agent input. The conditioning tank is configured to accept and contain an untreated liquid from the untreated liquid input and a conditioning agent from the conditioning agent input or from a holding tank containing sorbent or ion exchange resin. The untreated liquid and the conditioning agent are mixed and combined in the conditioning tank to produce a conditioned solution in the conditioning tank. A conditioned solution flow path fluidly connects the conditioning tank to a flow-through electrochemical reactor. The conditioned solution flow path is configured to accept the conditioned solution from the conditioning tank and to deliver the conditioned solution to the flow-through electrochemical reactor. The flow-through electrochemical reactor includes a housing having an internal liquid flow-path, a first electrode is disposed within the internal liquid flow-path, and a second electrode is spaced apart from the first electrode creating an electroactive gap between the first electrode and the second electrode. The conditioned solution passes through the electroactive gap. The untreated liquid includes a contaminant, and the conditioning agent comprises a material that combines with the contaminant to produce a complex and the complex is electrostatically attracted to a surface of the first electrode.

According to other examples, a method of removing a contaminant from a liquid includes mixing a liquid comprising a contaminant with a conditioning agent to create a conditioned solution including contaminant/conditioning agent complexes. The conditioned solution is delivered to a flow-through electrochemical reactor. Electrical current is applied to the flow-through electrochemical reactor to produce a first charged electrode and a second charged electrode. The first charged electrode and the second charged electrode are spaced apart from one another by an electroactive gap. At least some of the contaminant/conditioning agent complexes located within the electroactive gap are electrostatically attracted to a first electrode surface. The contaminant/conditioning agent complexes are electrochemically destroyed on the first electrode surface.

The foregoing examples of an electrochemical contaminant remediation system and method of removing a contaminant from a liquid with a flow-through electrochemical reactor may further include any one or more of the following optional features, structures, and/or forms.

In some optional forms, the untreated water may be cooled before entering the conditioning tank, or once in the conditioning tank.

In other optional forms, the cooling may be accomplished by a chiller or a heat transfer device.

In some optional forms, the contaminant comprises PFAS.

In some optional forms, the contaminant comprises 1,4-Dioxane.

In some optional forms, the conditioning agent comprises an additive chosen from one or more in the group of a polymer, a surfactant, a sorbent, and an ion exchange resin.

In some optional forms, the polymer comprises a poly-diallyl dimethyl ammonium chloride (poly(DADMAC)) cationic polymer.

In some optional forms, the polymer comprises a quaternary amine cationic polymer.

In some optional forms, the conditioning agent is a sorbent chosen from one or more in the group of organic sorbents and inorganic sorbents, for example, from one or more in the group of powdered activated carbon (PAC), granular activated carbon (GAC), carbon black, silica, and activated alumina.

In some optional forms, the conditioning agent is a chiller or heat transfer device that lowers the water temperature of the mixture of untreated liquid and the conditioning agent.

In some optional forms, the conditioned solution is held in the conditioning tank for a period of time before being delivered to the flow-through electrochemical reactor.

In some optional forms, the period of time is between 30 seconds and 60 minutes, for example, between 2 minutes and 60 minutes.

In some optional forms, a controllable valve is located between the conditioning tank and the flow-through electrochemical reactor.

In some optional forms, the first electrode is an anode having a hollow cylindrical shape.

In some optional forms, the second electrode is a cathode having a hollow cylindrical shape.

In some optional forms, a wall of the second electrode has a plurality of openings.

In some optional forms, the electroactive gap is less than 5 mm.

In some optional forms, the electrochemical reactor may comprise a plurality of electrode pairs.

In some optional forms, the electrochemical reactor may comprise between 1 and 10 pairs of electrodes.

In some optional forms, at least one of the first and second electrodes is solid.

In some optional forms, at least one of the first and second electrodes is porous.

In some optional forms, at least one of the first and second electrodes is a cathode comprising a titanium, either titanium metal or titanium oxide, and either solid or in a mesh.

In some optional forms, the first electrode and the second electrode are arranged concentrically, the first electrode comprising an anode being located within a cylindrical wall of the second electrode comprising a cathode. In other optional forms, the first electrode and second electrode may be reversed, with the second electrode comprising a cathode and the first electrode comprising an anode being arranged concentrically and the second electrode (cathode) being located within a cylindrical wall of the first electrode (anode).

In other optional forms, the solution flow path extends at least partially within the anode, longitudinally along an anode longitudinal axis, and at least partially radially outward, through a wall of the anode, substantially perpendicular to the anode longitudinal axis.

In other optional forms, the solution flow path extends radially, through a wall of the first electrode, radially across the electroactive gap, and radially through a plurality of openings in the second electrode wall.

In other optional forms, the flow-through electrochemical reactor may include a power source connected to the first electrode and to the second electrode.

In other optional forms, the flow-through electrochemical reactor may include an inlet cap at a first end of the housing, the inlet cap aligning and maintaining relative spacing between the first electrode and the second electrode.

In other optional forms, the flow-through electrochemical reactor may include an outlet guide flow cap at a second end of the housing, the outlet guide flow cap sealing the second end of the housing and receiving outlet flow from the exterior of the second electrode, the outlet guide flow cap also sealing one end of the first electrode.

In other optional forms, the second electrode may comprise: an iron based alloy such as stainless steel; a carbonaceous material such as graphite; dimensionally stable anodes (DSA); Magneli-phase titanium oxide (of general formula TiₙO₂ₙ₋₁); mixed metal oxides (such as, TiO₂, RuO₂, IrO₂, and/or SnO in combination with another metal oxide, typically titanium dioxide); boron doped diamond (BDD); or a combination thereof, for example, a magneli-phase titanium oxide coated onto a supporting mesh made of stainless steel.

In other optional forms, the first electrode may comprise dimensionally stable anodes (DSA), Magneli-phase titanium oxide (of general formula TiₙO₂ₙ₋₁), mixed metal oxides (such as, TiO₂, RuO₂, IrO₂, and/or SnO in combination with another metal oxide, typically titanium dioxide), boron doped diamond (BDD), or a combination thereof.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a schematic representation of an electrochemical contaminant remediation system including a flow-through electrochemical reactor.

FIG. 2 is a schematic representation of an alternate embodiment of an electrochemical contaminant remediation system including a flow-through electrochemical reactor.

FIG. 3 is an exploded perspective view of one example of a flow-through electrochemical reactor that may be used in the electrochemical contaminant remediation system of FIG. 1 or FIG. 2.

FIG. 4 is a side view of the flow-through electrochemical reactor of FIG. 3.

FIG. 5 is side cross-sectional view of the flow-through electrochemical reactor of FIG. 3.

FIG. 6 is a close-up side cross-sectional view of an inlet cap of the flow-through electrochemical reactor of FIG. 3.

FIG. 7 is a close-up side cross-sectional view of an outlet cap of the flow-through electrochemical reactor of FIG. 3.

### DETAILED DESCRIPTION

The electrochemical contaminant remediation systems and methods described herein advantageously remove contaminants from water rapidly and efficiently. Moreover, the systems and methods described herein are particularly useful for remediating persistent contaminants that are considered to be chemically stable and effectively have decay rates of essentially 0 under ambient conditions, such as PFAS.

While electrochemical remediation systems exist for the treatment of PFAS and other recalcitrant materials, they are limited by the mass transport of the contaminant to the electrode surface. Once sorbed to and/or proximate to the electrode surface, these contaminants can undergo direct electron transfer reactions and are then partially or completely transformed to components including, but not limited to, carbon dioxide, fluoride, and sulfate, rendering them less harmful to the environment and human health. However, the rate of contaminant destruction by existing systems and methods is very slow and inefficient.

The systems and methods described herein increase the rate of mass transport of contaminants proximate to an electrode surface and/or extent of sorption to an electrode surface by including conditioning agents, which increases the efficiency of the reactor, thereby improving throughput, performance, and/or reducing electrical requirements of the electrochemical reactor such as power and voltage.

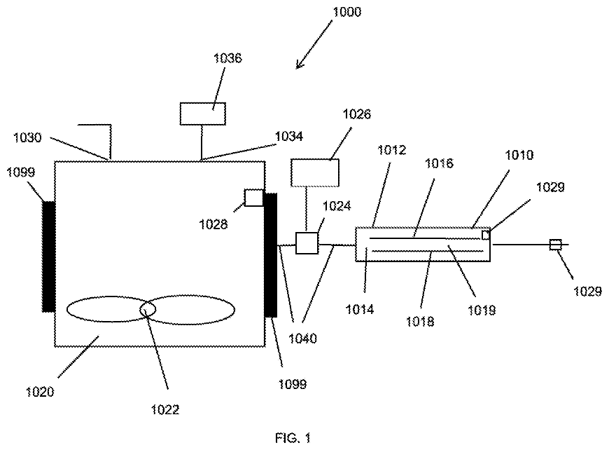

Turning now to FIG. 1, an electrochemical contaminant remediation system 1000 is schematically illustrated that includes a conditioning tank 1020. The conditioning tank 1020 has an untreated liquid input 1030 and a conditioning agent input 1034. The conditioning tank 1020 is configured to accept and contain an untreated liquid from the untreated liquid input 1030 and a conditioning agent from the conditioning agent input 1034. The conditioning agent input 1034 is operatively connected to a source of conditioning agent 1036. The untreated liquid and the conditioning agent are mixed and combined in the conditioning tank 1020 to produce a conditioned solution in the conditioning tank 1020. In some embodiments, the conditioning tank 1020 may include a mixing device 1022, such as a mechanical mixing device. In some embodiments, the mechanical mixing device may comprise rotating paddle, fan, or impeller blades. In other embodiments, the mixing device 1022 may comprise a flow-through mixing device, such as a venturi. In other embodiments, the mixing device 1022 may comprise a bubble aerator. In other embodiments, the mixing device 1022 may comprise a hydraulic mixing device.

Conditioning agents, as used herein, mean materials or mixtures of materials that are used to form a conditioning agent/contaminant complex, typically by charge neutralization, absorption, adsorption, or a combination thereof. More specifically, in the disclosed systems and methods, a contaminated liquid is cleaned or purified by the conditioning agent forming a complex with a contaminant material in the liquid. Thus, as used herein, conditioning agents are materials that combine, complex, sorb, interact, and/or bind with the contaminant molecule, typically PFAS. By combining with, or binding to, the contaminant molecule, the conditioning agent/contaminant complex acquires increased insolubility, which causes the combined conditioning agent/contaminant moiety to be more easily transported proximate to and/or more completely adsorbed to an electrode surface. The adsorbed conditioning agent/contaminant molecules are then degraded and destroyed by electrochemical reaction on or proximate to the electrode surface.

In other embodiments, the conditioning agent may comprise heat transfer. For example, a cooling jacket 1099 may cool the conditioned liquid in the conditioning tank 1020. While it is generally understood that heat increases chemical reactions, the inventor found, counterintuitively, that cooling the conditioned liquid enhances destruction of the contaminant (e.g., PFAS) in a flow-through electrochemical reactor 1010. In other embodiments, the untreated liquid may be cooled by a cooling device before delivery to the mixing tank 1020. While cooling alone can increase destruction of the contaminants, adding a further conditioning agent in the disclosed cooling systems and methods for remediating contaminants in liquids significantly increases destruction of the contaminants relative to cooling alone.

Conditioning agents useful in the apparatus and methods according to the disclosure can be categorized using one or more of four basic categories: polymers, including anionic polymers (e.g., polyanionic celluloses, or polyacrylamides also including acrylic acid salt monomeric units), nonionic polymers (e.g., polyacrylamides), cationic polymers (e.g., a polyquaternium also known as a quaternary ammonium polymer such as Polyquaternium 6, which is also referred to as Polydiallyldimethylammonium chloride and PolyDADMAC, and polyquaternium 7, and biopolymers, for example, chitosan, a sulfated glycosamino-glycan, a non-sulfated glycosamino-glycan, hyaluronic acid chondroitin sulfate, dextrose sulfate, dextran sulfate, ketran sulfate, heparin, cyclodextrin, heparin sulfate or combinations thereof, especially cationic biopolymers such as chitosan); surfactants including cationic surfactants (e.g., a quaternary ammonium surfactant such as cetrimonium bromide); high surface area materials (e.g., carbonaceous materials such as carbon black or activated carbons, particularly powdered activated carbon (PAC), granular activated carbon (GAC), and/or carbon black, and inorganic sorbents, such as silica or activated alumina); and ion exchange resins. PFAS (and other contaminants) may be removed from a liquid, such as water, by mixing a liquid comprising the contaminant (e.g., PFAS) with a conditioning agent in a conditioning tank to create a conditioned solution including contaminant/conditioning agent complexes. More specifically, a conditioning agent, such as a cationic polymer, an anionic polymer, a cationic surfactant, a high surface area sorbent, or an ion exchange resin, for example, PolyDADMAC, cetrimonium bromide, a PAC, and/or carbon black, is mixed with contaminant containing water, such as PFAS contaminated water. The conditioning agent combines, complexes, sorbs, interacts, and/or binds with the PFAS molecules (or other chemically stable, relatively soluble chemical contaminant) in the conditioning tank to form contaminant/conditioning agent complexes which are electrostatically attracted to, and are theorized to more readily adsorb to and/or be transported such that they are proximate to an electrode surface of the electrochemical reactor, thereby facilitating electron transfer from/to the contaminant and electrochemical degradation/destruction thereof. Because electrostatic attraction is useful for forming the complex, positively charged moieties have been shown to have significant effects with respect to PFAS species which are often negatively charged. It is believed that negatively charged moieties will have similar efficacy with respect to forming complexes with PFAS species that are positively charged.

A conditioned fluid flow path 1040 fluidly connects the conditioning tank 1020 to a flow-through electrochemical reactor 1010. In some embodiments, the conditioned fluid flow path 1040 may comprise a pipe or conduit. In other embodiments, the conditioned fluid flow path 1040 may comprise an open channel. An optional control valve 1024 may control the flow of conditioned liquid through the conditioned fluid flow path 1040. The control valve 1024 may be connected to a controller, such as a processor 1026, that sends control signals to the control valve 1024 based on time measurements, user commands, and/or inputs from sensors 1028 in the conditioning tank 1020 and/or from sensors 1029 in the flow-through electrochemical reactor 1010, or sensors (not shown) downstream of the flow through electrochemical reactor 1010. The sensors 1028, 1029 may be wirelessly connected to the processor 1026, or the connections may be wired (not shown). When the control signals are based on a time period, the time period is sufficient to ensure adequate mixing of the conditioning agent and the untreated liquid. Generally, any time period greater than one minute may be useful, but practically mixing for lengthy periods of time can be costly. In some embodiments, the time period may be between 30 seconds and 60 minutes, for example, between 2 minutes and 20 minutes, depending on the size of the conditioning tank 2020, the amount of conditioning agent to be mixed with the untreated liquid, and the reaction rate between the conditioning agent and the contaminant.

The conditioned fluid flow path 1040 is configured to accept the conditioned solution from the conditioning tank 1020 and to deliver the conditioned solution to the flow-through electrochemical reactor 1010. The flow-through electrochemical reactor 1010 includes a housing 1012 having an internal liquid flow-path 1014, a first electrode 1016 disposed within the solution flow-path 1014, and a second electrode 1018 spaced apart from the first electrode 1016 creating an electroactive gap 1019 between the first electrode 1016 and the second electrode 1018. While the embodiment of FIG. 1 illustrates a single electrode pair (first electrode 1016 and second electrode 1018), other embodiments may include more than one electrode pair in the flow-through electrochemical reactor 1010. For example, each flow-through electrochemical reactor 1010 may include 2, 3, 4, 5, 6, 7, 8, 9, or 10 or more electrode pairs in a single reactor housing 1012. Increasing the number of electrode pairs in a flow-through electrochemical reactor 1010 is one way to increase throughput of the system. In the illustrated embodiment, the first electrode 1016 and the second electrode 1018 comprise flat plates that are separated by the electroactive gap 1019. In other embodiments described below, the first electrode 1016 and the second electrode 1018 may comprise hollow concentrically oriented cylinders. The conditioned solution passes through the electroactive gap 1019.

The untreated liquid includes a contaminant and the conditioning agent combines, complexes, sorbs, interacts, and/or binds with the contaminant to produce a conditioning agent/contaminant complex and the conditioning agent/contaminant complex is advantageously electrostatically attracted to a surface of the first electrode 1016. It is theorized that this strategy is particularly advantageous for contaminants like PFAS that have appreciable solubility in most solvents/solutions and therefore cannot be adsorbed and/or be transported proximate to the electrode surface in appreciable amounts needed to accomplish effective treatment.

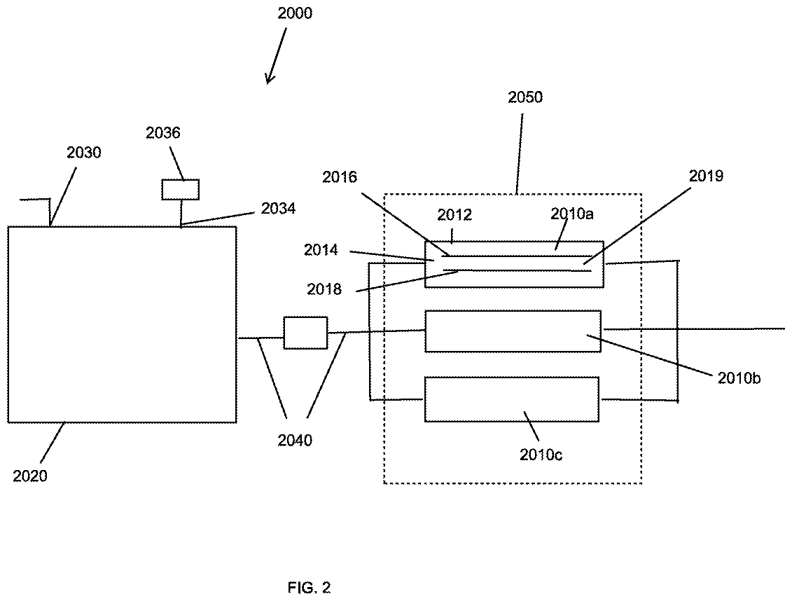

Turning now to FIG. 2, another embodiment of an electrochemical contaminant remediation system 2000 is schematically illustrated that includes a conditioning tank 2020. Any features described in the embodiment of FIG. 1 may be included in the embodiment of FIG. 2. For example, the sensors 1028, 1029 described above may be incorporated in the embodiment of FIG. 2, but are not shown or discussed for the sake of brevity.

The conditioning tank 2020 has an untreated liquid input 2030 and a conditioning agent input 2034. The conditioning tank 2020 is configured to accept and contain an untreated liquid from the untreated liquid input 2030 and a conditioning agent from the conditioning agent input 2034. The conditioning agent input 2034 is operatively connected to a source of conditioning agent 2036. The untreated liquid and the conditioning agent are mixed and combined in the conditioning tank 2020 to produce a conditioned solution in the conditioning tank 2020. In some embodiments, the conditioning tank 2020 may include a mixing device (not shown in FIG. 2), such as a mechanical mixing device. In some embodiments, the mechanical mixing device may comprise rotating paddle, fan, or impeller blades. In other embodiments, the mixing device may comprise a flow-through mixing device, such as a venturi or a static mixer. In other embodiments, the mixing device may comprise a bubble aerator. In other embodiments, the mixing device may comprise a hydraulic mixing device or may rely on turbulence from pumps or other conveyance devices.

A conditioned fluid path 2040 fluidly connects the conditioning tank 2020 to a plurality of flow-through electrochemical reactors 2010a, 2010b, 2010c. In the embodiment of FIG. 2, the flow-through electrochemical reactors 2010a, 2010b, 2010c are connected in parallel to the liquid flow path 2040. Increasing the number of electrochemical reactors 2010a, 2010b, 2010c is another way to increase throughput of the system. More or fewer flow-through electrochemical reactors 2010a, 2010b, 2010c, may be used in any embodiment. For example, 2, 4, 5, 6, or more flow-through electrochemical reactors may be used in the system. Furthermore, some or all of the flow-through electrochemical reactors may be connected in series. In other embodiments, some flow-through electrochemical reactors may be connected in series while other flow-through electrochemical reactors may be connected in parallel. In some embodiments, two or more of the flow-through electrochemical reactors may be further enclosed in an optional external housing 2050, thereby potentially obviating the need for individual conditioned fluid paths 1040, 2040 to each electrochemical reactor 2010a, 2010b, 2010c. Still further, in other embodiments, one or more of the reactor housings 2012 of the electrochemical reactors 2010a, 2010b, 2010c may include a plurality of electrode pairs.

The conditioned fluid flow path 2040 is configured to accept the conditioned solution from the conditioning tank 2020 and to deliver the conditioned solution to the flow-through electrochemical reactors 2010a, 2010b, 2010c. Similar to the embodiment of FIG. 1, at least one of the flow-through electrochemical reactors 2010a, 2010b, 2010c includes the housing 2012 having an internal liquid flow-path 2014, a first electrode 2016 disposed within the internal liquid flow-path 2014, and a second electrode 2018 spaced apart from the first electrode 2016 creating an electroactive gap 2019 between the first electrode 2016 and the second electrode 2018.

The conditioned solution passes through the electroactive gap 2019. The conditioned solution includes a contaminant and the conditioning agent, which comprises a material that combines, complexes, sorbs, interacts, and/or binds with the contaminant to produce a conditioning agent/contaminant complex and the conditioning agent/contaminant complex is electrostatically attracted to a surface of the first electrode 2016.

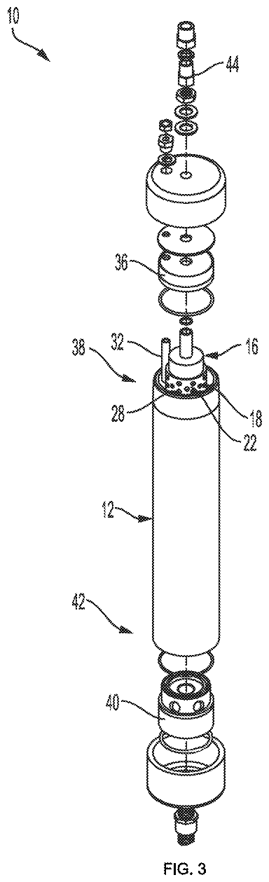

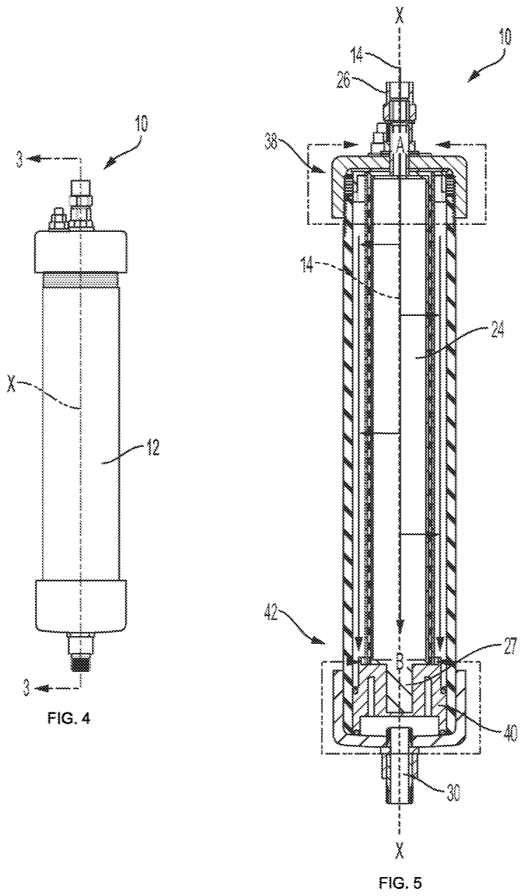

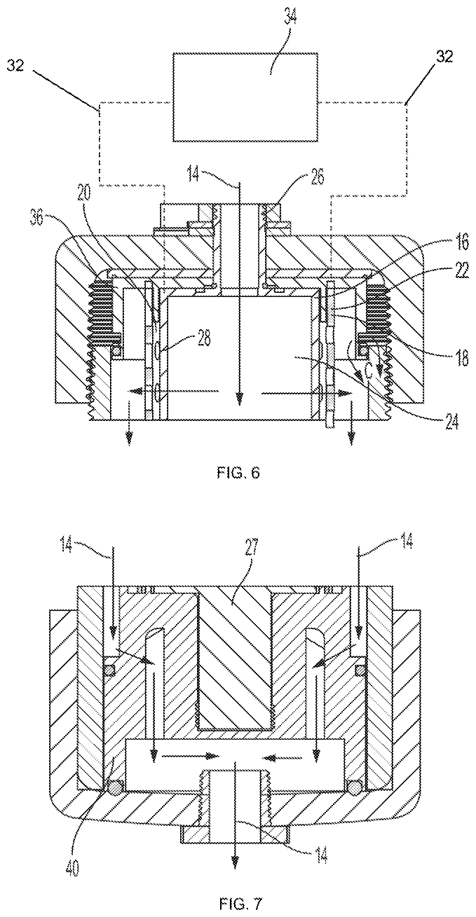

Turning now to FIGS. 3-7, one embodiment of a flow-through electrochemical reactor 10 is illustrated that may be employed in the electrochemical remediation systems described in FIGS. 1 and 2 above. The flow-through electrochemical reactor 10 includes a housing 12 having an internal liquid flow-path 14. A flow-through or solid first electrode, such as an anode 16, is disposed within the internal liquid flow path 14. In the illustrated embodiment, the anode 16 is annulus-shaped, in some cases a hollow cylinder, comprising a porous material. Advantageously, the flow-through electrochemical reactors described herein have no moving parts and therefore have long useful lives, while being relatively inexpensive and easy to manufacture. Moreover, the flow-through electrochemical reactors described herein surprisingly and unexpectedly can more efficiently treat contaminants present in the water/solution being treated, with significantly less clogging and short-circuiting compared to previous electrochemical reactor devices.

A second electrode, such as a cathode 18, is spaced apart from the anode 16, thereby creating an electroactive gap 20 between the anode 16 and the cathode 18. In other embodiments, the concentric arrangement of the anode 16 and the cathode 18 may be reversed.

Both the anode 16 and the cathode 18 in the flow-through electrochemical reactor illustrated in FIGS. 3-7 have a hollow cylindrical shape. In other embodiments, the anode 16 and the cathode 18 may have other shapes, such as flat plates or partial cylinders. In the embodiment of FIGS. 3-8, the anode 16 and the cathode 18 are arranged concentrically, the anode 16 being located within a cylindrical wall 22 of the cathode 18. The arrangement illustrated in FIGS. 3-7 may be used as an oxidizing reactor, which is particularly advantageous for destroying PFAS. In other embodiments, for example, when used as a reducing reactor (such that the electron transfer reactions take place on the cathode rather than the anode, i.e., the cathode is the working electrode), the anode 16 and the cathode 18 may be reversed (such as by reversing electrical connections and thus the polarity of the applied current) so that the cathode 18 may be located within a cylindrical wall of the anode 16. Regardless, the anode 16 and the cathode 18 may share a common longitudinal axis x. In the oxidizing electrochemical reactor configuration using a porous anode, an interior 24 of the porous anode 16 forms an initial flow path for the treated solution that enters the housing 12 through an inlet 26. As the conditioned solution fills the interior 24, it flows longitudinally, parallel to the longitudinal axis x and eventually reaches the bottom of the interior 24 where the conditioned solution is stopped by a plug 27. Once stopped, pressure builds up in the interior 24, which forces the conditioned solution to flow radially outward, perpendicular to the longitudinal axis x, through the wall of the anode 16.

The conditioned solution may pass through the wall of the anode 16 through porous openings in the anode, through perforations in the anode 16, or around the anode. Regardless, once the conditioned solution flows through and/or around the wall of the anode 16, the conditioned solution enters the electroactive gap 20. When in the electroactive gap 20, chemical reactions take place in the conditioned, which are driven by the electron flow supplied by the charged anode and cathode. The conditioned solution continues to flow radially outward through the cathode wall 22, for example, through a plurality of openings 28 in the cathode wall 22. Once through the cathode wall 22, the conditioned solution flows in the annular space formed between the cathode 18 and the housing 12, towards an outlet 30.

In alternate embodiments, one or both of the anode 16 and the cathode 18 may comprise solid cylindrical walls. In such embodiments, the internal liquid flow path may enter the hollow interior of the anode 16, flow downward until contracting the plug 27, then around a bottom end of the anode 16, through a gap between a bottom of the anode 16 wall and the plug 27, then upward through the electroactive gap 20 until contacting an inlet cap 36 and through a gap between the inlet cap 36 and the top end of the cathode 18, then downward on the outside of the cathode 18 to the outlet. In other alternate embodiments, the anode 16 or the cathode 18 may comprise solid cylindrical walls and the flow path may flow over the outer surface of the solid cylindrical wall and through the electroactive gap 20.

A power source 34 is connected to the anode 16 and to the cathode 18 via an electrical connection 32. Usually, the power source will be a DC power source. However, an AC power source could alternatively be used if the AC power source were transformed to DC in a transformer/rectifier. The power source 34 charges the anode 16 and the cathode 18 and conditioned solution fills the electroactive gap 20, electrons flow between the anode 16 and the cathode 18 and drive certain desirable chemical reactions causing oxidation or reduction of the formed complexes, which are particularly advantageous for degrading complexes comprising chemically stable and relatively soluble contaminants such as PFAS.

The inlet cap 36 is disposed at a first end 38 of the housing 12, the inlet cap 36 maintains proper spacing and orientation of the anode 16 relative to the cathode 18. An outlet guide flow cap 40 is disposed at a second end 42 of the housing 12. The outlet guide flow cap 40 seals the second end 42 of the housing 12 and receives outlet flow from the exterior of the cathode 18. The outlet guide flow cap 40 also seals one end of the interior 24 of anode 24 in conjunction with the plug 27.

An adapter base inlet 44 is disposed at the first end 38 of the housing 12, the adapter base inlet 44 providing plumbing and electrical connections while maintaining a pressure seal.

In some embodiments, the cathode 18 may comprise stainless steel, graphite, or other carbonaceous materials, dimensionally stable anodes (DSA), Magneli-phase titanium oxide (of general formula TiₙO₂ₙ₋₁, for example Ti₄O₇), mixed metal oxides (such as RuO2 (ruthenium oxide), IrO2 (iridium oxide), SnO (tin oxide) and/or PtO2 (platinum oxide) in combination with another metal oxide, typically titanium dioxide), or boron doped diamond (BDD), or a combination thereof. As used herein, the term “Magneli-phase titanium oxide” refers to a titanium oxide having general formula TiₙO₂ₙ₋₁, for example, Ti₄O₇, Ti₅O₉, Ti₆O₁₁, or a mixture thereof. In an embodiment, the Magneli-phase titanium oxide may be Ti₄O₇. In other embodiments, the Magneli-phase titanium oxide may be a mixture of Magneli-phase titanium oxides.

The anode 16 may comprise one of dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) and/or PtO₂ (platinum oxide in combination with another metal oxide, typically titanium dioxide), boron doped diamond (BDD), others, or a combination thereof.

The anode 16 and/or the cathode 18 may further comprise a catalytic coating. The catalytic coating may be between 1 μm and 30 μm thick, preferably between 5 μm and 20 μm, and more preferably between 10 μm and 20 μm. The catalytic coating may comprise a metal chosen from one or more in the group of ruthenium (Ru), rhodium (Rh), palladium (Pd), iridium (Ir), platinum (Pt), and tantalum (Ta). For example, the catalytic combination may comprise a combination of Ru and Ta, a combination of Rh and Ta, a combination of Pd and Ta, a combination of Ir and Ta, a combination of Pt and Ta, a combination of Ru and Ir, a combination of Rh and Ir, a combination of Pd and Ir, or a combination of Pt and Ir.

Once an appropriate flow-through reactor is constructed and arranged, the power is applied to the cathode(s) and the anode(s), and conditioned solution is passed through the electrodes resulting in electrochemical purification thereof. The purified solution is subsequently removed from the reactor. The applied power may be reversed periodically to prevent passivation of the electrodes and to remove foulants. In this embodiment, the cathode may include a Magneli-phase titanium oxide (of general formula TiₙO₂ₙ₋₁) or other electrode material. The reactor may be periodically backwashed or treated with acids or anti-scalants to purge built up solids that may have accumulated on the electrode.

In the illustrated embodiment, during use, power is applied to the cathode and the anode, and the treated solution is transferred to the inlet cap end of the reactor and into the tubular path located vertically in the center of the reactor. The electrochemically treated solution exits from the outlet of the tube. Typically, the orientation of the reactor is positioned (and thus rotated 180 degrees relative to the illustrations depicted in FIGS. 3-5.) so that the inlet is disposed at the bottom and the outlet is disposed at the top. In such an arrangement, the electrochemically treated solution flows from bottom to top. In other embodiments, the anode and cathode may be reversed, as discussed above.

The flow-through reactor, according to any embodiment, may further optionally include an oxidation-reduction potential sensor, a pH sensor, a chlorine sensor, a conductivity sensor, a flow rate sensor, a pressure sensor, a temperature sensor, one or more contaminant sensors (such as ammonia, TOC, UV-Vis, etc.), or a combination thereof.

As described above, one contaminant that may be advantageously mitigated, removed, and/or destroyed with the electrochemical contaminant remediation systems and flow-through electrochemical reactors described above is PFAS.

As previously described, the conditioning agent combines or binds with the PFAS molecules (or other chemically stable, relatively soluble chemical contaminant) in the conditioning tank to form the contaminant/conditioning agent complexes. The conditioned solution is delivered to a flow-through electrochemical reactor though a conditioned solution flow path. Electrical current is applied to the flow-through electrochemical reactor to produce a first charged electrode and a second charged electrode. The first charged electrode and the second charged electrode are spaced apart from one another by an electroactive gap. At least some of the joint contaminant/conditioning agent complexes located within the electroactive gap are electrostatically attracted to a first electrode surface. The contaminant/conditioning agent complexes have increased electrostatic attraction/sorption to the electrode surface in the flow-through electrochemical reactor relative to PFAS (or other chemically stable, relatively soluble chemical contaminant) molecules alone. In other words, the conditioning agent enhances transportation of the contaminant/conditioning agent complexes to the electrode surface. At least some of the joint contaminant/conditioning agent complexes are adsorbed to and/or are electrostatically attracted such that they are proximate to the first electrode surface. The joint contaminant/conditioning agent molecules are typically electrochemically destroyed on and/or proximate to the first electrode surface by direct transfer of electrons from the contaminant to the anode.

The conditioned solution may be held in the conditioning tank for a period of time before being delivered to the flow-through electrochemical reactor to ensure adequate mixing and formation of the contaminant/conditioning agent complexes. In some embodiments, an adequate period of time is between 30 seconds and 60 minutes, for example, between 2 min and 20 min.

The electrochemical contaminant remediation systems and flow-through electrochemical reactors described herein are advantageously used for treatment of water including, but not limited to removing contaminants, such as PFAS, from industrial waste streams as well as in municipal treatment plants for producing drinking water. The flow-through electrochemical reactors described herein are durable and scalable to meet relatively small personal or domestic demands as well as relatively large consumer, commercial, municipal or industrial demands.

As used herein, a flow-through electrochemical reactor refers to a reactor having a solution flow-path there through. The basic structural elements of a flow-through reactor include a housing having an inlet, an outlet, anodes, and cathodes, as described and shown for example in US Patent Publication No. 2019/0284066, which is hereby incorporated by reference in its entirety.

“About,” “approximately,” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one standard deviation, or within ±10%, 5%, 3%, or 1% of the stated value.

“Carbonaceous” as used herein means a material that comprises carbon. To be considered “carbonaceous” as used herein, a material should contain carbon with carbon atoms in other than a +4 oxidation state (such that the carbon atoms are capable of being oxidized). For example, carbonaceous materials include, but are not limited to, graphite, graphene, fullerenes, electrically conductive plastics, and diamond.

“Flow-through” anode or cathode as used herein refers to an anode or cathode electrode through which liquid is capable of flowing. Some non-limiting examples of flow-through electrodes include anodes or cathodes having an inner through path and/or comprising perforations, pores, or holes through which liquid can flow. The holes may be manufactured in the electrode by punching, for example. In one example, a solid but hollow cylindrical electrode may have an inner through path in which liquid can flow axially along a length of the hollow cylindrical electrode. Other non-limiting examples include anodes having a material wall comprising a porous material, for example, a hollow cylindrical anode or cathode having a material wall comprising a porous material through which liquid can flow both axially along the length of the anode or cathode as well as laterally through the cylindrical anode or cathode wall. Porous electrodes, for example, porous Magneli-phase, e.g., Ti₄O₇, anodes, are generally preferred in that they provide high surface area and increased contact with the water/solution to be electrochemically treated (typically, water). Solid plate-type anodes (that are not hollow and do not have an inner flow-through path) may also be used. Thus, both anodes and cathodes may be flow-through or solid.

In order for any electrochemical process to operate, there must be two (or more) electrodes functioning as anodes and cathodes. “Electroactive gap” as used herein means a gap or space between the electrodes functioning as the anode(s) and the cathode(s). In the disclosed flow-through electrochemical reactors, the electroactive gap is included in the flow path through which the solution, typically an aqueous phase to be treated, may flow and electrons may be transferred when the electrodes of the electrochemical reactors are powered. The current flow can cause various chemical reactions to take place within the electroactive gap that cause contaminants in the water/solution being treated to degrade and/or be rendered inactive, thereby purifying the water and converting non-potable water to potable water and/or remediating and thereby allowing the effluent stream to be released to the environment.

“Dimensionally stable anode” as used herein refers to an anode that displays relatively high conductivity and corrosion resistance. Generally, dimensionally stable anodes are manufactured from one or more metal oxides such as RuO₂ (ruthenium oxide), IrO₂ (iridium oxide), SnO (tin oxide) or PtO₂ (platinum oxide).

“Mixed metal oxide electrodes” (which may be used as the anode or as the cathode) are made by coating a substrate, such as a titanium plate or an expanded mesh, with metal oxides. One metal oxide is usually RuO₂ (ruthenium oxide), IrO₂ (iridium oxide), SnO (tin oxide), or PtO₂ (platinum oxide), or a combination thereof, which conducts electricity and catalyzes the desired reactions such as the production of chlorine gas in situ. The other metal oxide is typically titanium dioxide which does not significantly conduct or catalyze, but prevents corrosion of the interior.

The following examples are provided to illustrate the systems and methods for remediating contaminants in liquids disclosed herein.

### Example 1

In order to test the impact of cationic polymers on electrochemical remediation of PFAS, two different polymers were assessed. The first (C-591) is a poly(diallyldimethyl)ammonium chloride (Poly(DADMAC), while the second, C-577, is another polyquaternary amine.

Tests were conducted using leachate collected from a centralized water treatment facility that handles several different leachates. Because of the high levels of organics in the water, rather than test with raw leachate, the leachate was collected after treatment by coagulation with ferric chlorine and lime and clarification.

For the assessments, polymer was added to 3 gallons of leachate and then mixed for 15 minutes. Following this time, the water was introduced into reactors as illustrated in FIGS. 3-7 using a porous titanium oxide (Ti₄O₇) anode and a titanium metal mesh cathode and recirculated for 6 hours at greater than 3 V. Water samples were collected at 2, 4, and 6 hours and sent for PFAS analysis by EPA method 1633. Two tests were conducted with the polymers added and a control test without polymer added was also performed.

Once results were obtained, the first order kinetic decay rates were determined for PFAS reduction. The first order kinetic decay (min-1) constants are shown below.

| | Untreated | C-591 | C-577 |
|---|---|---|---|
| Total PFAS | 1.0E−03 | 2.0E−03 | 3.0E−03 |

These results indicate that mixing of conditioning agents and contaminants, particularly PFAS, in a liquid, through addition of conditioning agents to untreated liquid, particularly, addition of cationic polymers, advantageously and significantly improved destruction of PFAS by approximately 300% relative to electrochemical treatment alone (under the same operating conditions).

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An electrochemical contaminant remediation system comprising:
a conditioning tank including an untreated liquid input and a conditioning agent input, the conditioning tank being configured to accept untreated liquid from the untreated liquid input and conditioning agent from the conditioning agent input such that the untreated liquid and the conditioning agent are mixed and combined in the conditioning tank to produce a conditioned solution in the conditioning tank;
a conditioned fluid flow path fluidly connecting the conditioning tank to a first flow-through electrochemical reactor, the conditioned fluid flow path being configured to accept the conditioned solution from the conditioning tank and to deliver the conditioned solution to the flow-through electrochemical reactor, the first flow-through electrochemical reactor comprising:
a housing including an internal liquid flow-path;
a first electrode disposed within the internal liquid flow-path;
a second electrode spaced apart from the first electrode creating an electroactive gap between the first electrode and the second electrode, the conditioned solution passing through the electroactive gap, and
wherein the untreated liquid comprises a contaminant and the conditioning agent comprises a material that combines with the contaminant to produce a contaminant/conditioning agent complex and the contaminant/conditioning agent complex is electrostatically attracted to a surface of the first electrode.

2. The electrochemical contaminant remediation system of claim 1, wherein the contaminant comprises recalcitrant organic material.

3. The electrochemical contaminant remediation system of claim 1, wherein the conditioning agent comprises an additive chosen from one or more in the group of a polymer, a surfactant, a sorbent, and an ion exchange resin.

4. The electrochemical contaminant remediation system of claim 3, wherein the conditioning agent comprises a cationic polymer.

5. The electrochemical contaminant remediation system of claim 3, wherein the conditioning agent comprises a sorbent chosen from one or more in the group of powdered activated carbon (PAC), granular activated carbon (GAC), carbon black, silica, and activated alumina.

6. The electrochemical contaminant remediation system of claim 1, wherein the conditioning agent comprises an anion exchange resin.

7. The electrochemical contaminant remediation system of claim 1, further comprising a controllable valve between the conditioning tank and the flow-through electrochemical reactor.

8. The electrochemical contaminant remediation system of claim 1, wherein the first electrode is an anode having a hollow cylindrical shape.

9. The electrochemical contaminant remediation system of claim 1, wherein the second electrode is a cathode having a hollow cylindrical shape.

10. The electrochemical contaminant remediation system of claim 1, wherein a wall of the second electrode has a plurality of openings.

11. The electrochemical contaminant remediation system of claim 1, further comprising a mixing device in the conditioning tank.

12. The electrochemical contaminant remediation system of claim 1, further comprising a second flow-through electrochemical reactor connected to the internal liquid flow path.

13. The electrochemical contaminant remediation system of claim 12, wherein the first flow-through electrochemical reactor and the second flow-through electrochemical reactor are connected in series.

14. The electrochemical contaminant remediation system of claim 12, wherein the first flow-through electrochemical reactor and the second flow-through electrochemical reactor are connected in parallel.

15. A method of removing a contaminant from a liquid, the method comprising:
mixing a liquid comprising a contaminant with a conditioning agent to create a conditioned solution including joint contaminant/conditioning agent complexes;
delivering the conditioned solution to a flow-through electrochemical reactor;
applying electrical current to the flow-through electrochemical reactor to produce a first charged electrode and a second charged electrode, the first charged electrode and the second charged electrode being spaced apart from one another by an electroactive gap;
electrostatically attracting at least some of the joint contaminant/conditioning agent complexes located within the electroactive gap to a first electrode surface; and
electrochemically destroying the joint contaminant/conditioning agent molecules on or proximate to the first electrode surface.

16. The method of claim 15, wherein the contaminant comprises PFAS.

17. The method of claim 15, wherein the conditioning agent comprises an additive chosen from one or more in the group of a polymer, a surfactant, a sorbent, and an ion exchange resin.

18. The method of claim 15, wherein the conditioning agent comprises a cationic polymer.

19. The method of claim 15, wherein the conditioning agent comprises a sorbent chosen from one or more in the group of powdered activated carbon (PAC), granular activated carbon (GAC), carbon black, silica, and activated alumina.

20. The method of claim 15, wherein the conditioning agent comprises an anion exchange resin.

21. The method of claim 15, wherein mixing the liquid comprising a contaminant and the conditioning agent is carried out in a conditioning tank before delivering the conditioned solution to the flow-through electrochemical reactor.

22. The method of claim 21, wherein mixing is carried out for a period of time between 30 seconds and 60 minutes.
